(19) United States
(12) Patent Application Publication
(10) Pub. No.: US 2025/0251559 A1
(43) Pub. Date: Aug. 7, 2025

(54) OPTICAL FIBER UNIT FOR AIR BLOWN FIBER AND METHOD OF MANUFACTURING THE SAME

(71) Applicant: OASISCABLE CO., LTD., Gwangju (KR)

(72) Inventor: Boyoung AHN, Gwangju (KR)

(73) Assignee: OASISCABLE CO., LTD., Gwangju (KR)

(21) Appl. No.: 19/035,095

(22) Filed: Jan. 23, 2025

(30) Foreign Application Priority Data
Feb. 2, 2024 (KR) 10-2024-0016648

(51) Int. Cl. G02B 6/44

(52) U.S. Cl. CPC G02B 6/443; G02B 6/4486

(57) ABSTRACT

An optical fiber unit for an air blown fiber, which is laid in a tube using air pressure, includes at least one optical fiber, a protection layer surrounding the optical fiber, and a sheath layer surrounding the protection layer, wherein a plurality of outer grooves are formed on an outer surface of the sheath layer such that a constant distance between the plurality of outer grooves is maintained in a longitudinal direction and a circumferential direction of the sheath layer, and since the outer grooves maintain the constant distance in the circumferential direction of the sheath layer, a lifting force and a driving force due to a frictional force between the outer grooves and the air pressure are generated, a transferring distance of the optical fiber unit is increased, a transferring speed is increased, and the optical fiber unit is prevented from being twisted in any one direction.

### CROSS-REFERENCE TO RELATED APPLICATION

This application claims the priority benefit of Korean Patent Application No. 10-2024-0016648 filed on Feb. 2, 2024, and all the benefits accruing therefrom under 35 U.S.C. § 119, the contents of which are incorporated by reference in their entirety.

### BACKGROUND

The present invention relates to an optical fiber unit and a method of manufacturing the same, and more specifically, to an optical fiber unit which is laid in an air blowing method and a method of manufacturing the same.

Optical fibers have low transmission loss and a large bandwidth and therefore are widely used for long-distance high-speed transmission media. Recently, a method of laying an optical fiber using air pressure has been widely adopted.

According to an air blowing method, a tube, which is called a micro tube or duct and is formed of a polymer material, is buried in a buried area in advance, and then an optical fiber unit is blown and laid therein by air pressure. A surface of the air blown fiber unit is processed to greatly receive the air pressure.

According to the conventional technology, in order for an optical fiber unit to receive more air pressure, grooves or protrusions are formed in or on an outer portion of a sheath layer of the optical fiber unit. Since the grooves or the protrusions are formed long in a longitudinal direction of the sheath layer, and a direction in which the grooves or the protrusions are formed is the same as a direction in which the air pressure is applied, the optical fiber unit cannot effectively receive the air pressure. That is, although the optical fiber unit receives a lifting force due to the air pressure in the tube, the optical fiber unit hardly receives a driving force in a direction in which the optical fiber unit moves forward. Accordingly, a transferring distance that the optical fiber unit can be laid at once and a transferring speed can decrease.

### SUMMARY

The present invention is directed to providing an optical fiber unit for an air blown fiber that allows a transferring distance and a transferring speed to be increased, and a method of manufacturing the same.

One aspect of the present invention provides an optical fiber unit for an air blown fiber, which is laid in a tube using air pressure, the optical fiber unit including at least one optical fiber, a protection layer surrounding the optical fiber, and a sheath layer surrounding the protection layer, wherein a plurality of outer grooves are formed on an outer surface of the sheath layer such that a constant distance between the plurality of outer grooves is maintained in a longitudinal direction and a circumferential direction of the sheath layer, and since the outer grooves maintain the constant distance in the circumferential direction of the sheath layer, a lifting force and a driving force due to a frictional force between the outer grooves and the air pressure are uniformly applied along a circumference of the sheath layer, a transferring distance of the optical fiber unit is increased, a transferring speed is increased, and the optical fiber unit is prevented from being twisted in any one direction.

According to embodiments of the present invention, in each of the outer grooves, a depth may increase from a front end toward a rear end in a direction in which the air pressure is applied to increase the frictional force between the outer grooves and the air pressure.

According to embodiments of the present invention, the outer grooves may be alternately disposed on the outer surface of the sheath layer to increase the frictional force between the outer grooves and the air pressure.

According to embodiments of the present invention, a plurality of inner grooves may be formed on an inner surface of the sheath layer, which are continuous along the longitudinal direction of the sheath layer while maintaining a constant distance in the circumferential direction of the sheath layer, and form an air layer between the sheath layer and the protection layer.

Another aspect of the present invention provides a method of manufacturing an optical fiber unit for an air blown fiber, the method including forming a sheath layer for surrounding a protection layer by allowing at least one optical fiber and the protection layer surrounding the optical fiber to pass through a first through hole of a nipple and supplying a polymer resin to an outer surface of the protection layer through a second through hole of a dice accommodating the nipple, and forming a plurality of outer grooves on an outer surface of the sheath layer by pressing the sheath layer using a roller guide including a plurality of protrusions such that a constant distance between the plurality of outer grooves is maintained in a longitudinal direction and a circumferential direction of the sheath layer.

According to embodiments of the present invention, in the forming of the outer grooves, the roller guide may adjust a pressure applied to the sheath layer and a temperature of the roller guide and transmit the adjusted pressure and temperature to the sheath layer to accurately form the outer grooves.

According to embodiments of the present invention, in each of the outer grooves, a depth may increase from a front end to a rear end in a direction in which air pressure is applied to increase a frictional force between the outer grooves and the air pressure.

According to embodiments of the present invention, the outer grooves may be alternately disposed on the outer surface of the sheath layer to increase a frictional force between the outer grooves and air pressure.

According to embodiments of the present invention, a plurality of protruding parts may be provided in a circumferential direction of the nipple to have a constant distance between the plurality of protruding parts, and the method may further comprise forming a plurality of inner grooves on an inner surface of the sheath layer by allowing the resin to pass over the protruding parts while the forming of the sheath layer is performed, which are continuous along the longitudinal direction of the sheath layer while maintaining a constant distance in the circumferential direction of the sheath layer, and form an air layer between the sheath layer and the protection layer.

According to embodiments of the present invention, each of the protruding parts may have a shape in which a height of the protruding part gradually increases and then remains constant from a front end toward a rear end in a direction in which the resin is supplied such that the protruding parts from obstructing a flow of the resin.

According to the present invention, a plurality of outer grooves are formed on an outer surface of the sheath layer and spaced apart from each other in a longitudinal direction and a circumferential direction of the sheath layer, and a depth of each of the outer grooves increases from a front end toward a rear end in a direction in which the air pressure is applied. Accordingly, a frictional force of the optical fiber unit against the air pressure can be increased, and a transferring distance and a transferring speed of the optical fiber unit using the air pressure can be increased.

In addition, a plurality of inner grooves, between which a constant distance is maintained in the circumferential direction of the sheath layer and which extend in the longitudinal direction of the sheath layer and form an air layer between the protection layer and the plurality of inner grooves, are formed. Accordingly, since an adhesive force between the sheath layer and the protection layer is decreased, the sheath layer can be easily separated, since the air layer buffers an external impact, the optical fiber can be protected from the external impact, and since a weight of the optical fiber unit is reduced due to the inner grooves, a transferring speed and a transferring distance of the optical fiber unit can be increased.

### BRIEF DESCRIPTION OF THE DRAWINGS

FIG. 1 is a perspective view illustrating an optical fiber unit according to one embodiment of the present invention.

FIG. 2 is a cross-sectional view illustrating the optical fiber unit illustrated in FIG. 1.

FIGS. 3 to 6 are perspective views illustrating the optical fiber unit for describing other examples of an outer groove.

FIG. 7 is a flowchart for describing a method of manufacturing an optical fiber unit according to one embodiment of the present invention.

FIG. 8 is a cross-sectional view illustrating an extruder for performing the method of manufacturing an optical fiber unit.

FIG. 9 is a perspective view for describing a nipple illustrated in FIG. 8.

FIG. 10 is a side view illustrating a roller guide for performing the method of manufacturing an optical fiber unit.

FIG. 11 is a front view illustrating the roller guide illustrated in FIG. 10.

### DETAILED DESCRIPTION

Hereinafter, the present invention will be described in detail with reference to the accompanying drawings. While the present invention may be modified in various ways and have various alternative forms, specific embodiments thereof will be described in detail below. However, there is no intent to limit the present invention to the specific embodiments, and it should be understood that the present invention covers all modifications, equivalents, and alternatives falling within the range of the spirit and scope of the present invention. When the present invention is described with reference to the accompanying drawings, like numbers refer to like elements. In the accompanying drawings, sizes of structures may be greater than those of actual structures for clarity of the present invention.

Although terms such as “first,” “second,” and the like may be used to describe various components, the components are not limited by these terms. These terms are only used to distinguish one component from another component. For example, a first component may be named a second component, and similarly, a second component may also be named a first component without departing from the scope of the present invention.

Terms used herein are only for the purpose of describing particular embodiments and are not intended to limit the present invention. Singular forms are intended to include the plural forms, unless the context clearly indicates otherwise. It should be understood that the terms “comprise,” “comprising,” “include,” and/or “including” used in the present specification specify the presence of stated features, numbers, steps, operations, elements, components, or combinations thereof but do not preclude the presence or addition of one or more other features, numbers, steps, operations, elements, components, or combinations thereof.

Unless otherwise defined, all terms including technical and scientific terms used herein have meanings which are the same as meanings generally understood by those skilled in the art. Terms, such as those defined in commonly used dictionaries, should be interpreted as having meanings that are consistent with their meanings in the context of the relevant art and will not be interpreted in an idealized or overly formal sense unless expressly so defined here.

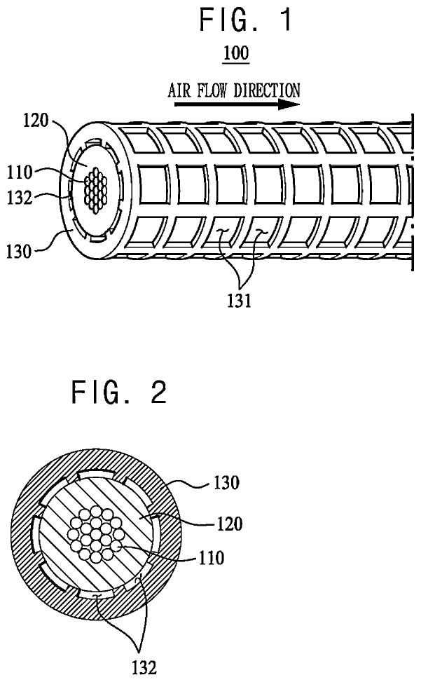

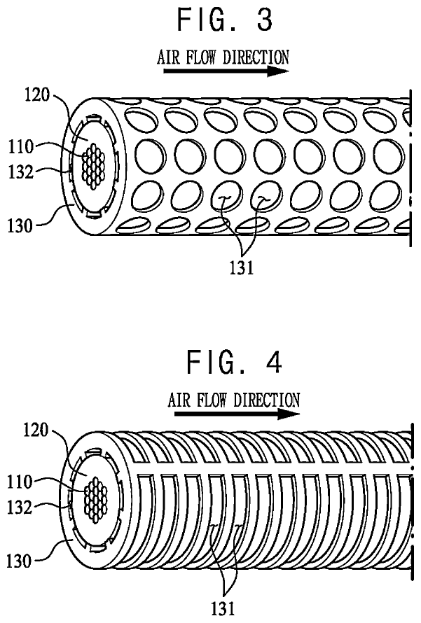

FIG. 1 is a perspective view illustrating an optical fiber unit according to one embodiment of the present invention, FIG. 2 is a cross-sectional view illustrating the optical fiber unit illustrated in FIG. 1, and FIGS. 3 to 6 are perspective views illustrating the optical fiber unit for describing other examples of an outer groove.

Referring to FIGS. 1 to 6, an optical fiber unit 100 includes an optical fiber 110 including a core layer and a clad layer, a protection layer 120 surrounding the optical fiber 110, and a sheath layer 130 surrounding the protection layer and is laid in an air blowing method. A cross section of the optical fiber unit 100 may have a circular shape.

The optical fiber 110 may include the core layer for transmitting an optical signal and the clad layer surrounding the core layer and may be provided as a single or plurality of optical fibers.

In addition, an outer surface of the optical fiber 110 may include a coloring layer. The coloring layer allows the optical fiber 110 to be easily distinguished when the optical fiber unit 100 is installed or repaired.

In addition, when the plurality of optical fibers 110 are provided, one or more optical fibers may be replaced by a tension line.

The protection layer 120 is for protecting the optical fiber 110, is formed of a durable plastic, acrylate, or nylon material, and buffers an external impact applied to the optical fiber 110.

The sheath layer 130 is for protecting the protection layer 120 from external foreign matter and moisture and may be formed of a polyethylene (PE), polyurethane, or polyvinyl chloride (PVC) material.

Each of the protection layer 120 and the sheath layer 130 may have substantially a pipe shape.

Outer grooves 131 are formed on an outer surface of the sheath layer 130 to increase a frictional force between the sheath layer 130 and air pressure when laying is performed using the air pressure. The outer grooves 131 may be disposed to maintain a constant distance therebetween in a longitudinal direction and a circumferential direction of the sheath layer 130.

For example, as illustrated in FIG. 1, the outer grooves 131 may be disposed on the outer surface of the sheath layer 130 to have a grid shape.

In this case, as illustrated in FIGS. 1, 3, and 4, each of the outer grooves 131 may have any of various shapes, such as a polygonal shape, for example, a quadrangular shape, a circular shape, an oval shape, a semicircular shape, a star shape, and a stripe shape.

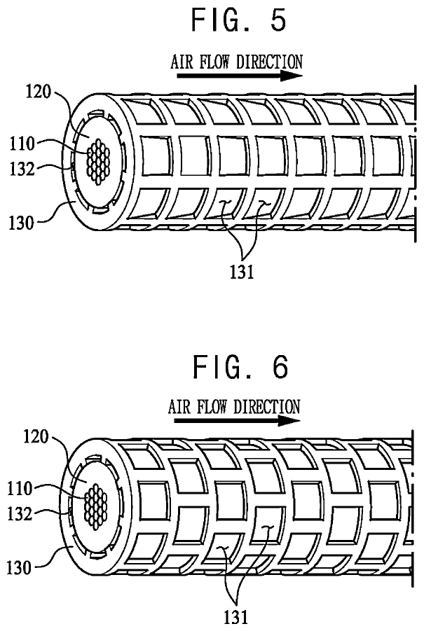

In addition, as illustrated in FIG. 5, in each of the outer grooves 131, a depth may increase from a front end to a rear end in a direction in which air pressure is applied. Accordingly, a frictional force between the air pressure and the outer grooves 131 may increase when the air pressure is applied to lay the optical fiber unit 100.

In addition, as illustrated in FIG. 6, the outer grooves 131 may be alternately disposed on the outer surface of the sheath layer 130. When air pressure is applied for laying the optical fiber unit 100, the air pressure does not pass between the external grooves 131 but rather comes into contact with the external grooves 131, thereby increasing the frictional force between the air pressure and the optical fiber unit 100.

Although not illustrated in the drawings, the outer grooves 131 may be alternately disposed on the outer surface of the sheath layer 130, and in each of the outer grooves 131, a depth may also increase from a front end toward a rear end in a direction in which air pressure is applied.

The outer grooves 131 formed on the outer surface of the sheath layer 130 serve to decrease a contact area of the sheath layer 130 with an inner surface of a tube and increase a contact surface of the sheath layer 130 with air when the optical fiber unit 100 is laid in a narrow space such as a tube. Accordingly, due to the outer grooves 131, the contact area between the outer surface of the sheath layer 130 and the inner surface of the tube is reduced, thereby a frictional force is reduced, but an area exposed to an air flow when the laying is performed is increased, and thus the frictional force between the sheath layer 130 and the air pressure may be increased.

Specifically, since the constant distance is maintained between the outer grooves 131 in the longitudinal direction and the circumferential direction of the sheath layer 130, and an arrangement of the outer grooves 131 is perpendicular to a flow direction of the air pressure, the optical fiber unit 100 may effectively receive the air pressure. That is, the optical fiber unit 100 may receive not only a lifting force but also a driving force in a direction in which air flows due to the frictional force with the air pressure in the tube. Accordingly, a transferring distance and a transferring speed may increase when the optical fiber unit 100 is laid.

In addition, since the outer grooves 131 maintain the constant distance therebetween along a circumference of the sheath layer 130, when the optical fiber unit 100 is laid using the air pressure, airflow around the sheath layer 130 is uniformly resisted by the outer grooves 131. That is, the frictional force between the sheath layer 130 and the air pressure may be uniformly applied along the circumference of the sheath layer 130. Accordingly, when the laying is performed using the air pressure, the optical fiber unit 100 may be laid without being twisted in any one direction.

A plurality of inner grooves 132 may be formed on an inner surface of the sheath layer 130. The inner grooves 132 maintain a constant distance therebetween in the circumferential direction of the sheath layer 130 and are consecutively provided in the longitudinal direction of the sheath layer 130.

As an example, the inner grooves 132 may have a straight shape, a spiral shape, a wave shape, or the like in the longitudinal direction of the sheath layer 130. In addition, a cross section of each of the inner grooves 132 may have any of various shapes such as polygonal shapes, for example, a triangular shape and a quadrangular shape, a semicircular shape, an arc shape, a trapezoid shape, and an uneven shape.

The inner grooves 132 form an air layer between the protection layer 120 and the sheath layer 130.

The air layer may decrease an adhesive force between the sheath layer 130 and the protection layer 120 such that the sheath layer 130 may be easily separated. In addition, since the air layer buffers an external impact, the protection layer 120 and the optical fiber 110 may be protected from the external impact.

In addition, since a weight of the optical fiber unit 100 may be reduced due to the inner grooves 132, that is, the air layer, the transferring distance and the transferring speed of the optical fiber unit 100 may increase.

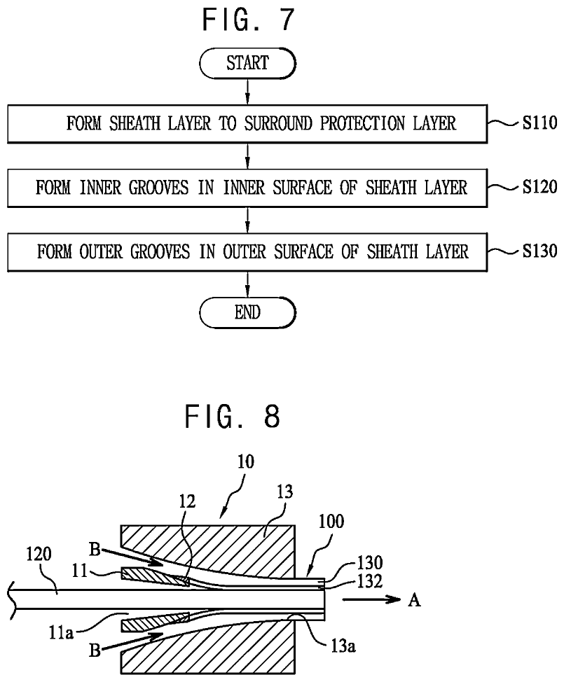

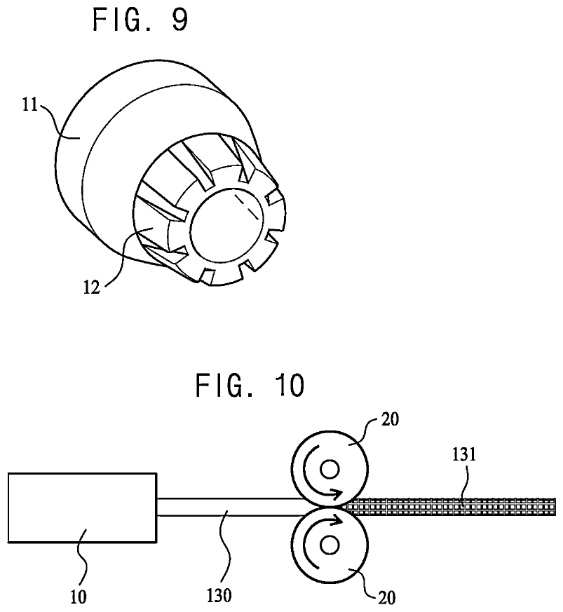

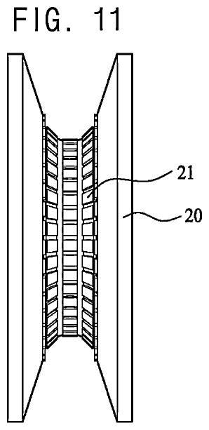

FIG. 7 is a flowchart for describing a method of manufacturing an optical fiber unit according to one embodiment of the present invention, and FIG. 8 is a cross-sectional view illustrating an extruder for performing the method of manufacturing an optical fiber unit. FIG. 9 is a perspective view for describing a nipple illustrated in FIG. 8, and FIG. 10 is a side view illustrating a roller guide for performing the method of manufacturing an optical fiber unit. FIG. 11 is a front view illustrating the roller guide illustrated in FIG. 10.

A method of manufacturing the optical fiber unit 100 will be described below.

First, referring to FIGS. 7 to 9, the sheath layer 130 for surrounding the optical fiber 110 and the protection layer 120 are formed using an extruder 10 (S110).

Specifically, at least one optical fiber 110 including the core layer and the clad layer and the protection layer 120 surrounding the optical fiber 110 pass through a first through hole 11a of a nipple 11 in a direction of arrow A, and a polymer resin is supplied to an outer surface of the protection layer 120 through a second through hole 13a of a dice 13 accommodating the nipple 11 in a direction of arrow B to form the sheath layer 130 surrounding the protection layer 120.

That is, the optical fiber 110 may be provided to the nipple 11 while surrounded by the protection layer 120.

Then, the plurality of inner grooves 132 forming the air layer between the inner surface of the sheath layer 130 and the protection layer 120 are formed on the inner surface of the sheath layer 130 using the extruder 10 (S120).

The forming of the sheath layer 130 and the forming of the inner grooves 132 are performed at the same time.

Specifically, a plurality of protruding parts 12 are provided on an end portion of an outer surface of the nipple 11 to be spaced a constant distance from each other in a circumferential direction.

In the forming of the sheath layer 130, the resin passes over the protruding parts 12 to form the inner grooves 132 on the inner surface of the sheath layer 130, which are continuous along the longitudinal direction of the sheath layer 130 while maintaining a constant distance in the circumferential direction of the sheath layer 130.

As an example, the inner grooves 132 may have a straight shape, a spiral shape, a wave shape, or the like in the longitudinal direction of the sheath layer 130.

In the forming of the sheath layer 130, when the nipple 11 is in a fixed state, the inner grooves 132 are formed in the straight shape.

In the forming of the sheath layer 130, when the nipple 11 or the optical fiber 110 and the protection layer 120 are rotated clockwise or counterclockwise, the inner grooves 132 are formed in a spiral shape.

In the forming of the sheath layer 130, when the nipple 11 or the optical fiber 110 and the protection layer 120 are alternately rotated a predetermined angle clockwise and counterclockwise, the inner grooves 132 are formed in a wave shape.

Each of the protruding parts 12 may have a shape in which a height gradually increases and then remains constant from a front end toward a rear end in a direction in which the resin is supplied. Accordingly, the protruding parts 12 may not hinder a flow of the resin, and thus the resin may be smoothly supplied.

On the other hand, the height of the protruding parts 12 may be constant.

A cross-sectional shape of each of the inner grooves 132 may be determined according to a cross-sectional shape of each of the protruding parts 12. A cross section of the protruding part 12 may have any of various shapes such as polygonal shapes, for example, a triangular shape and a quadrangular shape, a semicircular shape, an arc shape, a trapezoid shape, and an uneven shape.

Then, referring to FIGS. 7, 10, and 11, the plurality of outer grooves 131 are formed on the outer surface of the sheath layer 130 using roller guides 20 (S130).

Specifically, a plurality of protrusions 21 are provided on a surface of each of the roller guides 20 to maintain a constant distance therebetween in a circumferential direction of the roller guide 20 and in a longitudinal direction of the roller guide 20. Each of the protrusions 21 may have any of various shapes such as a polygonal shape, for example, a quadrangular shape, a circular shape, an oval shape, a semicircular shape, and a star shape.

The protrusions 21 may be disposed in a grid shape along a circumference of the roller guide 20.

In addition, in each of the protrusions 21, a depth may increase from a front end toward a rear end in a rotational direction of the roller guide 20.

In addition, the protrusions 21 may be disposed to be alternate with each other.

The roller guides 20 rotate to press the sheath layer 130 to form the outer grooves 131 on the outer surface of the sheath layer 130 such that the outer grooves 131 are spaced apart from each other in the longitudinal direction and the circumferential direction of the sheath layer 130.

As an example, the roller guides 20 may be provided on and under the sheath layer 130, and the roller guides 20 provided thereon and thereunder may press the sheath layer 130 at the same time. The roller guide 20 provided on the sheath layer 130 forms the outer grooves 131 in an upper surface of the sheath layer 130, and the roller guide 20 provided under the sheath layer 130 may form the outer grooves 131 in a lower surface of the sheath layer 130.

On the other hand, the roller guides 20 may be provided on an upper side, a lower side, a left side, and a right side of the sheath layer 130, the roller guides 20 provided on the upper and lower sides press the sheath layer 130 at the same time, and then the roller guides 20 provided on the left and right sides press the sheath layer 130. The roller guide 20 provided on the upper side of the sheath layer 130 may form the outer grooves 131 in the upper surface of the sheath layer 130, the roller guide 20 provided on the lower side of the sheath layer 130 may form the outer grooves 131 in the lower surface of the sheath layer 130, the roller guide 20 provided on the left side of the sheath layer 130 may form the outer grooves 131 in a left surface of the sheath layer 130, and the roller guide 20 provided on the right side of the sheath layer 130 may form the outer grooves 131 in a right surface of the sheath layer 130.

In the forming of the outer grooves 131, the roller guide 20 may adjust a pressure applied to the sheath layer 130, adjust a temperature of the roller guide 20, and transmit the adjusted pressure and temperature to the sheath layer 130. Accordingly, the outer grooves 131 may be accurately formed in the sheath layer 130.

The outer grooves 131 formed by the roller guides 20 may be disposed in a grid shape on the outer surface of the sheath layer 130.

In addition, in each of the outer grooves 131, a depth may increase from a front end toward a rear end in the direction in which the air pressure is applied to increase a frictional force between outer grooves 131 and the air pressure.

In addition, the outer grooves 131 may be alternately disposed on the outer surface of the sheath layer 130 to increase the frictional force between the sheath layer 130 and the air pressure.

Hereinafter, a process of laying the optical fiber unit 100 using air pressure will be simply described.

First, the tube is installed in a section in which the optical fiber unit 100 is to be laid, and then the optical fiber unit is blown by the air pressure to a place at which the optical fiber unit is needed using a laying apparatus. In general, about 1 km of the optical fiber unit may be laid in one operation without connection. When the optical fiber unit is laid in a longer path compared to a conventional length, the optical fiber unit is laid from a center of the section in both directions or an optical fiber bundle is blown in one direction, and the optical fiber bundle exiting through an opposite side is wound and is continuously laid in a remaining section. Through this method, the optical fiber unit may be laid even in a section which is longer than 1 km using the air pressure, and when the laying is completed, since the optical fiber corresponding to a length occupied by the laying apparatus is exposed, a separate protection coupling tube (tube closedown) part is used to seal and protect the exposed optical fiber.

While the present invention has been described above with reference to exemplary embodiments, it may be understood by those skilled in the art that various modifications and changes of the present invention may be made within a range not departing from the spirit and scope of the present invention defined by the appended claims.

1. An optical fiber unit for an air blown fiber, which is laid in a tube using air pressure, comprising:
at least one optical fiber;
a protection layer surrounding the optical fiber; and
a sheath layer surrounding the protection layer,
wherein a plurality of outer grooves are formed on an outer surface of the sheath layer such that a constant distance between the plurality of outer grooves is maintained in a longitudinal direction and a circumferential direction of the sheath layer, and
since the outer grooves maintain the constant distance in the circumferential direction of the sheath layer, a lifting force and a driving force due to a frictional force between the outer grooves and the air pressure are uniformly applied along a circumference of the sheath layer, a transferring distance of the optical fiber unit is increased, a transferring speed is increased, and the optical fiber unit is prevented from being twisted in any one direction.

2. The optical fiber unit of claim 1, wherein, in each of the outer grooves, a depth increases from a front end toward a rear end in a direction in which the air pressure is applied to increase the frictional force between the outer grooves and the air pressure.

3. The optical fiber unit of claim 1, wherein the outer grooves are alternately disposed on the outer surface of the sheath layer to increase the frictional force between the outer grooves and the air pressure.

4. The optical fiber unit of claim 1, wherein a plurality of inner grooves are formed on an inner surface of the sheath layer, which are continuous along the longitudinal direction of the sheath layer while maintaining a constant distance in the circumferential direction of the sheath layer, and form an air layer between the sheath layer and the protection layer.

5. A method of manufacturing an optical fiber unit for an air blown fiber, the method comprising:
forming a sheath layer for surrounding a protection layer by allowing at least one optical fiber and the protection layer surrounding the optical fiber to pass through a first through hole of a nipple and supplying a polymer resin to an outer surface of the protection layer through a second through hole of a dice accommodating the nipple; and
forming a plurality of outer grooves on an outer surface of the sheath layer by pressing the sheath layer using a roller guide including a plurality of protrusions such that a constant distance between the plurality of outer grooves is maintained in a longitudinal direction and a circumferential direction of the sheath layer.

6. The method of claim 6, wherein, in the forming of the outer grooves, the roller guide adjusts a pressure applied to the sheath layer and a temperature of the roller guide and transmits the adjusted pressure and temperature to the sheath layer to accurately form the outer grooves.

7. The method of claim 5, wherein, in each of the outer grooves, a depth increases from a front end to a rear end in a direction in which air pressure is applied to increase a frictional force between the outer grooves and the air pressure.

8. The method of claim 5, wherein the outer grooves are alternately disposed on the outer surface of the sheath layer to increase a frictional force between the outer grooves and air pressure.

9. The method of claim 5, wherein:
a plurality of protruding parts are provided in a circumferential direction of the nipple to have a constant distance between the plurality of protruding parts, and
the method further comprises forming a plurality of inner grooves on an inner surface of the sheath layer by allowing the resin to pass over the protruding parts while the forming of the sheath layer is performed, which are continuous along the longitudinal direction of the sheath layer while maintaining a constant distance in the circumferential direction of the sheath layer, and form an air layer between the sheath layer and the protection layer.

10. The method of claim 9, wherein each of the protruding parts has a shape in which a height of the protruding part gradually increases and then remains constant from a front end toward a rear end in a direction in which the resin is supplied such that the protruding parts from obstructing a flow of the resin.
